(19) United States
(12) Patent Application Publication
(10) Pub. No.: US 2003/0195962 A1
(43) Pub. Date: Oct. 16, 2003

(54) Load balancing of servers

(76) Inventors: Satoshi Kikuchi, Yokohama (JP); Michiyasu Odaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/233,572

(22) Filed: Sep. 4, 2002

(30) Foreign Application Priority Data
Apr. 10, 2002 (JP) 2002-107282

(51) Int. Cl. G06F 15/16

(52) U.S. Cl. 709/226; 709/241; 709/228

(57) ABSTRACT

A server load balancing method is provided for making the load of each server uniform. The server load balancing method is arranged to include a server pool definition unit of storing the information on plural servers as a server pool, a processing status storing unit of storing a processing status of each server, and a request distributing unit of breaking a series of requests received from the client and sending each request to the server with the least load on the request-receiving time.

### BACKGROUND OF THE INVENTION

The present invention relates to a load balancing device that is served to distribute a request from a client to any one of the servers related thereto.

In order to realize smooth communications of an intranet and an extranet, an electronic mail system has been more and more common which system is arranged to transfer a document created by an information processing apparatus such as a PC (Personal Computer) through a network like a LAN (Local Area Network). As the so-called address book function, that is, a function of searching a mail address of a recipient, the directory service such as the CCITT recommendation X.500 (SO9594) is started to be in use.

The IETF (Internet Engineering Task Force), which is a standardization engine of the internet, includes the LDAP (Lightweight Directory Access Protocol) (RFC2251) standardized as a protocol between the directory client and the server on the TCI/IP. A user may make access to the directory server such as the X.500 from the directory client through the LDAP, for searching target information like his or her mail address. Further, the LDAP includes the specified directory update system operations such as add, delete and modify of an entry and modify of an entry name.

The directory service may correspond with a distribution system architecture and thus replicate the information managed by each directory server to another server. Hence, if one server is failed, another server is enabled to continue the service. Moreover, the load of access may be distributed into plural servers.

In preparation for a server's failure, the conventional directory client has selected any one of the servers through the use of a specific algorithm such as the round robin and then has sent the LDAP request. However, the method of switching the server by the client needs to set a list of target servers to each client and thus needs an intricate maintenance accompanied with promotion in adding a new server, for example. In order to overcome this shortcoming, as disclosed in JP-A-2001-229070, a new method has been proposed which is arranged to find a server to be accessed among a plurality of directory servers and to send the request to the server.

On the other hand, if the conventional server switching method by the client is applied to load balancing, as a shortcoming, each client determines a server to be accessed by itself, so that load of each server is not constantly balanced.

As a technology of overcoming this shortcoming, there may be referred a load balancing device (referred to as a switch) described in pages 28 to 39 of IEEE INTERNET COMPUTING, MAY and JUNE 1999. The switch is located between the client and the server, undertakes all the requests from the clients, and sends a series of requests to the most suitable server.

The aforementioned conventional switch brings about the following shortcomings.

The conventional switch has as a processing target the HTTP (Hyper Text Transfer Protocol) in which each request is independent so that the requests may be distributed each by each. As to the other application protocol rather than that, load balancing is carried out at the layer four level, that is, the TCP connection unit.

FIG. 4 shows an example of a communication sequence of load balancing through the use of the conventional switch. For a quite short time, each of the three clients 2a, 2b and 2c sends two search requests in one LDAP connection on each individual timing. The switch 17 operates to distribute each request to two servers 1a and 1b. The LDAP is a protocol that is arranged to transfer a series of requests and responses on the set-up connection. When the LDAP connection is set up, the TCP connection is set up.

As mentioned earlier, the conventional switch 17 realizes load balancing at each TCP connection unit, so that all requests on the same LDAP connection may be sent to the same server. That is, the request-distributing target is determined when the LDAP connection is set up. It is not changed until the LDAP connection is disconnected. For example, the requests 18 and 21 the client 2a has sent are included in one LDAP connection. Hence, these requests are sent as requests 24 and 27 to the same server la. Likewise, the requests 19 and 22 the client 2b has sent are sent to the server 1b. The requests 20 and 23 the client 2c has sent are sent to the server 1a. At a time, four requests are distributed to the server 1a, while only two requests are distributed to the server 1b.

As noted above, the conventional load balancing method through the use of the switch brings about a load shift of each server, is degraded in local response performance, and thus impairs the user's convenience. In order to meet the performance request of the system, it is necessary to add the redundant server, which leads to increasing the cost of introducing the information processing apparatus in proportional to a system scale.

### SUMMARY OF THE INVENTION

The present invention provides a server load balancing technology which makes load of each server more uniform.

According to the invention, in the information processing system composed of the servers and the clients, the server load balancing method is arranged to send each request received from the client to the server with the least load on the request-receiving time independently of the connection established with the client.

In more particular, according to the server load balancing method of the invention, the information processing system composed of the servers and the clients, in one aspect, includes a server pool defining unit of storing information about plural servers as a server pool, a processing status storing unit of storing a processing status of each server, and a request distributing unit of sending each request received in the connection established with the client to the server with the least load on the receipt time.

### BRIEF DESCRIPTION OF THE DRAWINGS

FIG. 1 is a block diagram showing a system according to an embodiment of the invention;

FIG. 2 is a view showing an information composition of a processing status storing unit 6 included in the first embodiment;

FIG. 3 is a view showing an information composition of a server pool definition file 9 included in the first embodiment;

FIG. 4 is an explanatory view showing a communication sequence in the conventional load balancing system;

FIG. 5 is an explanatory view showing a communication sequence in the load balancing system according to this embodiment;

FIG. 6 is a flowchart showing an operation of a connection managing unit 8 according to the present invention;

FIG. 7 is a flowchart showing an operation of a request distributing unit 5 according to the present invention;

FIG. 8 is a view showing an information composition included in the processing status storing unit 6 according to the second embodiment; and

FIG. 9 is a view showing an information composition of a server pool definition file 9 according to the second embodiment.

### DESCRIPTION OF THE EMBODIMENTS

Hereafter, one embodiment of the embodiment will be described with reference to the appended drawings. The same components have the same reference numbers throughout the drawings.

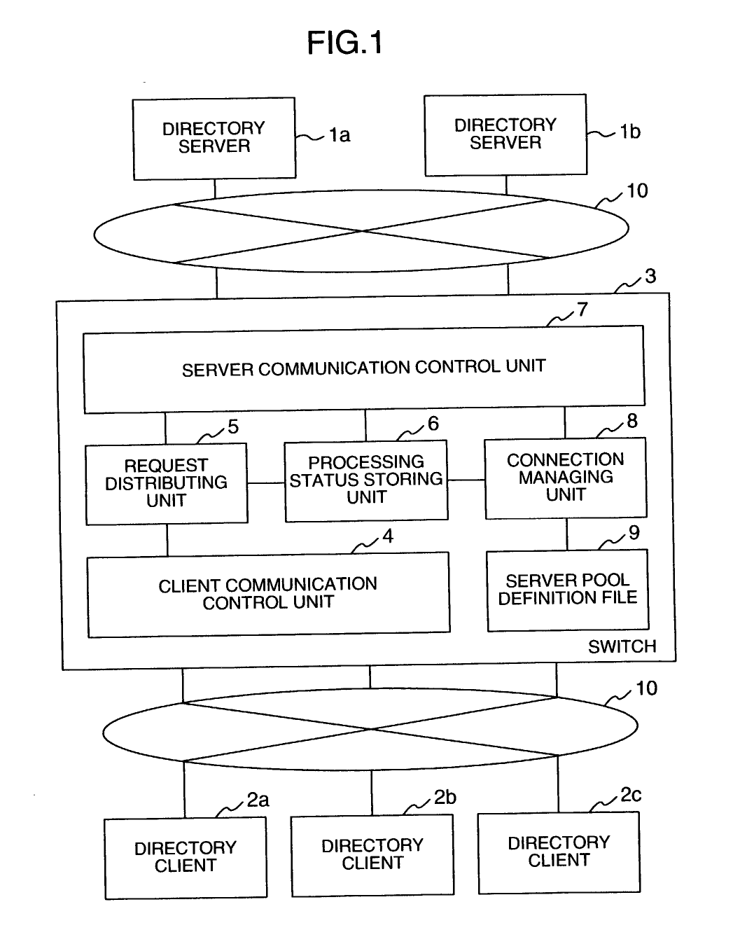

FIG. 1 is a block diagram showing a directory system to which the present invention applies. A switch 3, two directory servers 1a and 1b, and three directory clients 2a, 2b and 2c are connected through a network 10 like a LAN.

The switch 3 includes a client communication control unit 4 of executing a communication with a client, a server communication control unit 7 of executing a communication with a server, a server pool definition file 9 of defining a group of servers to which load is to be distributed (referred to as a server pool), a connection managing unit 8 of managing a connection with the server, a processing status storing unit 6 of storing a processing status of each server, and a request distributing unit 5 of distributing a request received from the client to the most suitable server at the time.

The switch 3 is composed of a CPU, a memory, internal communication wires like buses, a secondary storage unit like a harddisk, and a communication interface. The communication interface is connected with the network, through which interface the switch 3 is communicated with the client and the server. The memory stores a program of realizing the following processes through the use of the CPU and the necessary data. The program and the data may be prestored, introduces from another server through the network or another storage medium or introduces from the secondary storage unit.

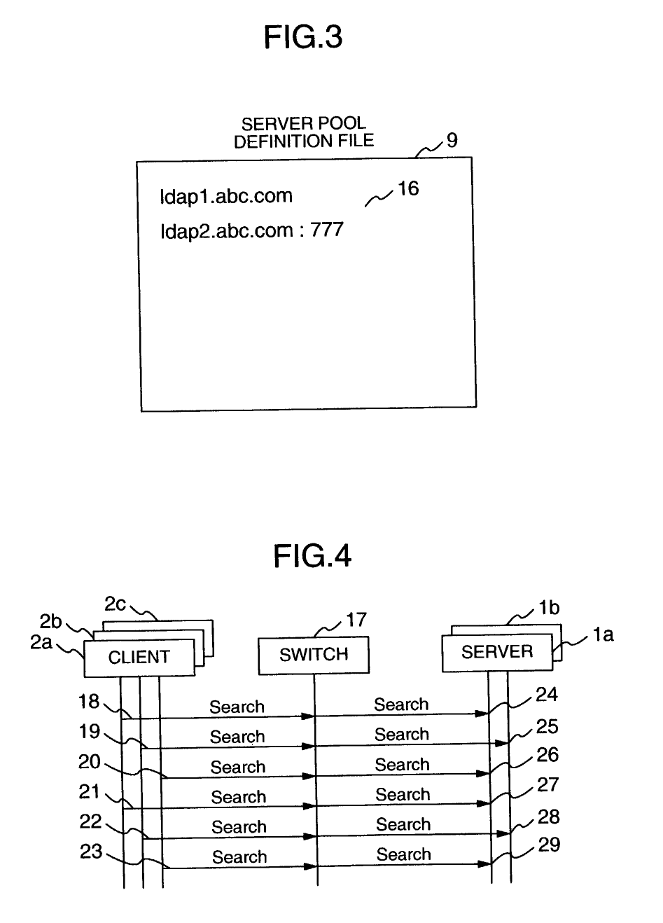

FIG. 3 illustrates an example of a server pool definition file 9. An administrator of the system describes the names 16 of plural servers to which load is to be distributed in a server pool definition file 9. The name 16 includes a DNS name (or IP address) of the server and a port number, both of which are delimited by “:”. The port number may be omitted. If omitted, the standard port number “389” may be used therefor.

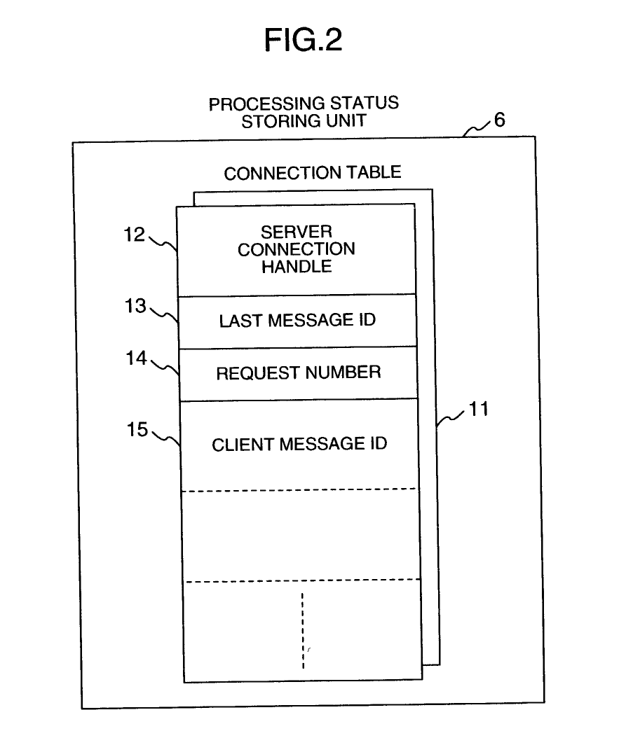

FIG. 2 shows information components stored in the processing status storage unit 6, which is composed of a connection table 11 of storing information about a connection established with the server. The connection table 11 is composed of an array structure that corresponds to the number of connections established with the server.

Each connection table 11 includes an area 12 of storing handle information for uniquely identifying a connection with the server, an area 13 of storing a message ID (that is called a last message ID) of the request lastly sent to the server, an area 14 of storing the number of requests being processed by the server, and an area 15 of storing a client message ID contained in the request received from the client. The client message ID 15 of each connection table 11 is composed of an array structure that corresponds to the number of requests being processed by the server.

In turn, the description will be oriented to the operation of the switch of this embodiment.

First, the method of establishing the connection with the server will be described with reference to FIG. 6. When the switch is started, the connection managing unit 8 establishes the LDAP connection with each server belonging to the server pool. The connection managing unit 8 reads the server name 16 described at the head of the server pool definition file 9, builds up a Bind request of establishing the LDAP connection with the server, and requests the server communication control unit 7 to send the server (S601).

After connected with the server, the connection managing unit 8 operates to generate a new connection table 11 inside the processing status storing unit 6, register the handle information for identifying the LDAP connection established with the server in the area 12, and initialize the last message ID 13 as “1” and the number of requests 14 as “0” (S602).

The connection managing unit 8 repeats the processes of S601 and S602 as to all the servers described in the server pool definition file 9 for establishing the LDAP connection between the switch and the server (S603).

Then, the switch 3 terminates the start process, from which the service may be started.

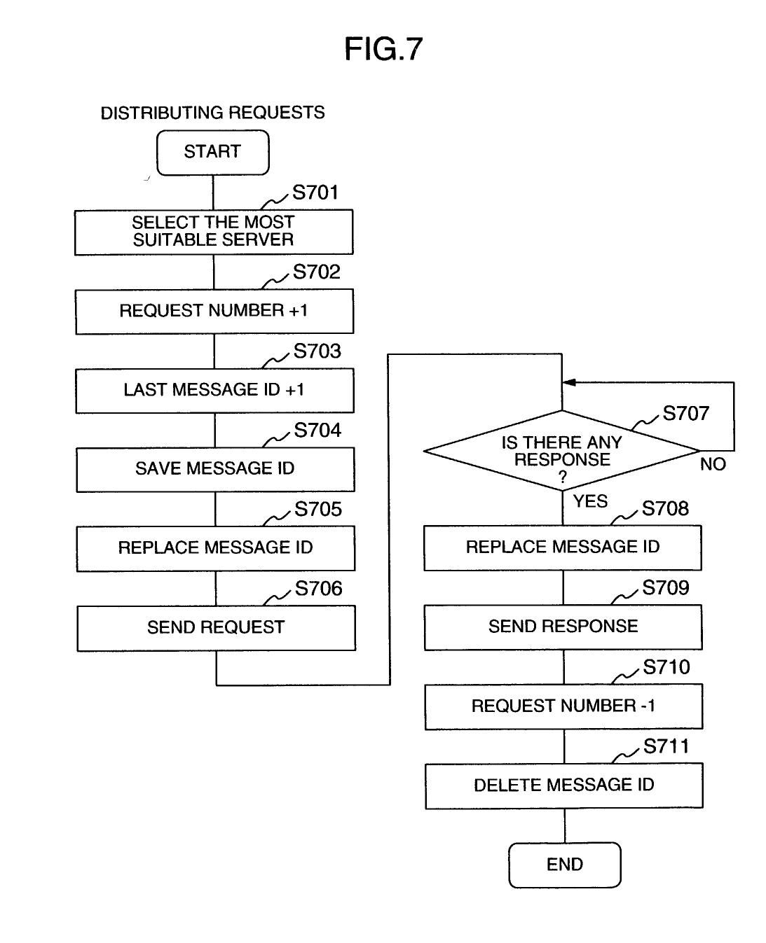

The method of distributing the request will be described with reference to FIG. 7.

The client communication control unit 4 receives the Bind request of establishing the LDAP connection from the client, when the control unit 4 returns a response of indicating a success of establishing the connection to the client without sending the request to any one of the servers. This makes it possible to establish the LDAP connection between the client and the switch.

When the client communication control unit 4 receives a request except for a Bind an Unbind from the client, the request distributing unit 5 operates to select the most suitable server to the processing from the server pool and then send the request to the selected server.

When the client communication control unit 4 receives the request from the client, the request distributing unit 5 selects the most suitable server to the process of the request by searching the connection table 11 with the least numeric value registered in the number of requests 14 from the processing status storing unit 6 (S701).

Then, the operation is executed to refer to the connection table 11 of the selected most suitable server and then add “1” to the request number 14 and the last message ID 13 (S702, S703).

In succession, the request distributing unit 5 operates to generate a new client message ID area 15 inside the connection table 11 and temporarily save a message ID contained in the received request (S704).

Then, the message ID of the request received from the client is replaced with the ID indicated by the last message ID 13 (S705).

Next, the handle information registered in the server connection handle 12 is notified to the server communication control unit 7 for requesting to send the request to the selected server (S706). Then, the request distributing control unit 5 waits for a response from the server (S707).

When the server communication control unit 7 receives a response from the server, the request distributing unit 5 replaces the message ID of the received response with the client message ID 15 saved in the step S704 (S708) and then requests the client communication control unit 4 to send the response (S709).

Lastly, the request distributing unit 5 subtracts “1” from the request number 14 (S710) and deletes the client message ID area 15 generated in the step S704 (S711). Then, the distributing process of the request is completed.

As mentioned above, according to this embodiment, each one of plural requests included in the LDAP connection established with one client is allowed to be sent to the server with the smallest load when the request is received. This allows the load to be distributed more effectively.

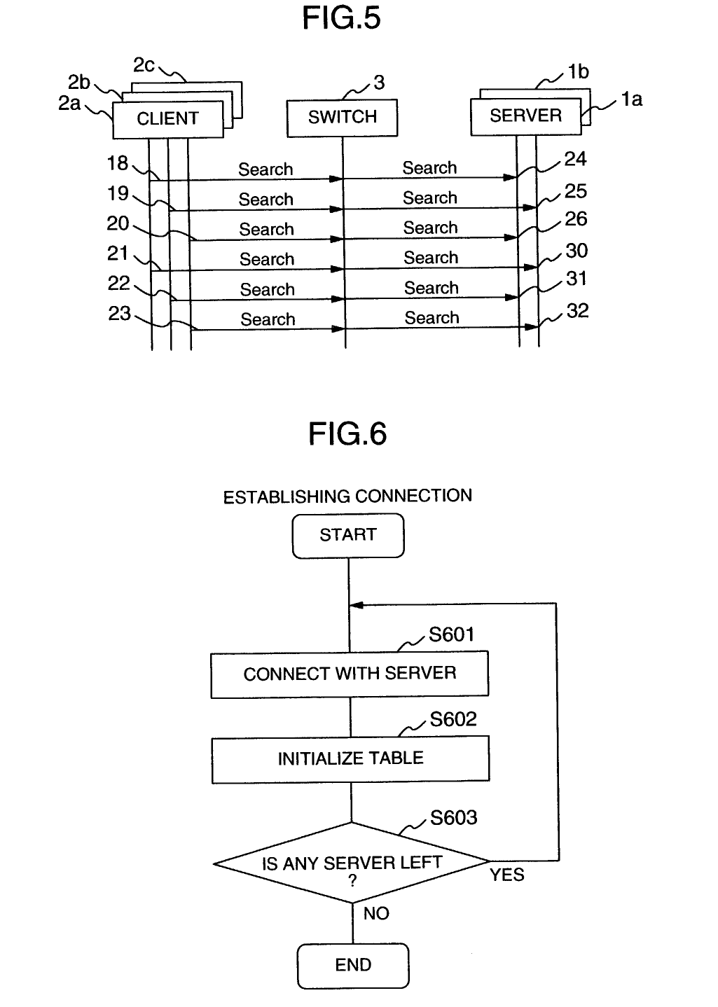

FIG. 5 shows an example of a communication sequence of load balancing to which the switch 3 of this embodiment is applied.

The requests 18 and 21 sent by the client 2a are distributed as the requests 24 and 30 to the servers 1a and 1b, respectively, though they are sent with the same LDAP connection. Likewise, the requests 19 and 22 sent by the client 2b and the requests 20 and 23 sent by the client 2c are distributed to the servers 1a and 1b, respectively. That is, a group of three requests are distributed to the server 1a and 1b, respectively.

As mentioned above, the switch 3 of this embodiment is arranged to send a series of requests (for example, the requests 24 and 30) received through one client connection through a different connection established with the server or send the requests (for example, the requests 24, 26, 31) received through a different connection established with the client through the same server connection.

The foregoing description has concerned with one embodiment to which the server load balancing method of this invention is applied. According to this embodiment, each of one or more requests received from the client in one client connection is sent to the most suitable server at each request-receiving time through the connection to the server. In comparison with the conventional switch that is arranged to determine the request-distributing target on each connection unit, irrespective of the client connection, the requests may be distributed to the most suitable server on the receiving time. This allows a load shift of each server to be lessened more.

The foregoing system may be arranged to establish plural connections with one of the server. This arrangement makes it possible to execute the servers process in another database system with no LDAP feature of sending a plurality of requests on one connection in a multiplexing manner.

In turn, the description will be oriented to the second embodiment of the invention, in which the same process as that of the first embodiment is not described herein.

The foregoing first embodiment has concerned with the load distributing method through the use of a single server pool. This embodiment may request load balancing through the use of plural server pools according to some ways of use.

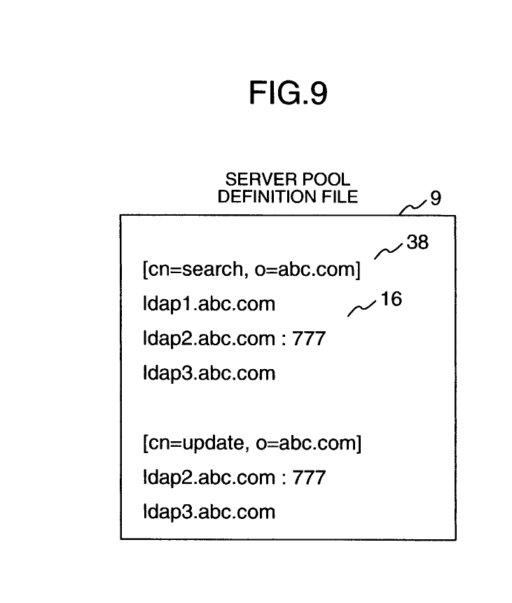

FIG. 9 shows an example of a server pool definition file 9 included in a switch arranged to correspond with plural server pools. A reference number 38 denotes a pool identifier for uniquely identifying each server pool. The administrator of the system enables to define a group of servers to which load is to be distributed in each pool. According to this embodiment, a parameter of the Bind request regulated in RFC2251, “name”, is specified as a pool identifier. The parameter “name” is a title of an identify that uses the directory server, which corresponds to the user name or the user ID in another information processing system.

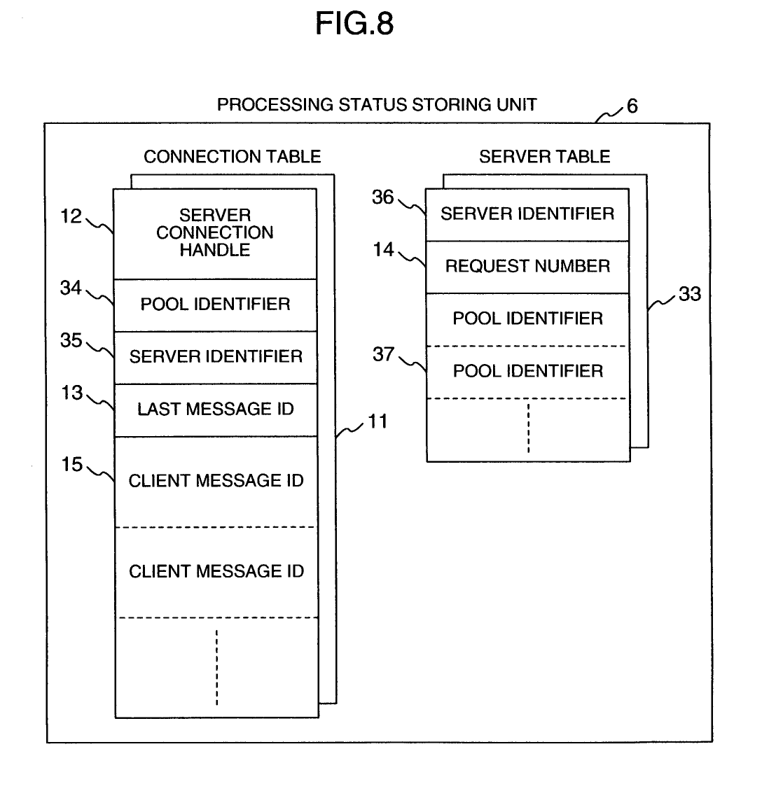

FIG. 8 shows the information components of the processing status storing unit 6 according to this embodiment. The information components are composed of a server table 33 of storing the status of each server and a connection table 11. The server table 33 composes an array structure that corresponds to each server of all the server pools.

Each server table 33 is composed of an area 36 of storing information for uniquely identifying a server, such as a server name, an area 14 of storing a request number being processed by the server, and an area 37 of storing an identifier of a server pool to which the server belongs. The pool identifier 37 of each server table 33 composes an array structure that corresponds to the number of all pools to which the server belongs.

Each connection table 11 is composed of a server connection handle area 12, an area 34 of storing an identifier of a server pool to which the connection belongs, an area 35 of storing the information for uniquely identifying the server, a last message ID area 13, and a client message ID area 15.

In turn, the description will be oriented to the operation of the switch 3 according to this embodiment.

When the switch 3 is started, the connection managing unit 8 is connected with the server described in the server pool definition file 9 (S601) and then generates a new connection table 11 inside the processing status storing unit 6. Next, the connection managing unit 8 registers the handle information for identifying a connection established with the server and the pool identifier and the server identifier described in the server pool definition file 9 in the areas 12, 34 and 35, respectively. Further, the connection managing unit initializes the value of the last message ID 13 into “I”. If there exists no server table 33 with the server identifier registered therein, the connection managing unit 8 generates a new server table 33, registers the pool identifier and the server identifier in the areas 37 and 36, respectively and initializes the request number 14 into “0”. On the other hand, if there exists any server table 33 with the server identifier registered therein, the pool identifier 37 is additionally registered thereto (S602).

The connection managing unit 8 repeats the processes of S601 and S602 about all servers of all pools described in the server pool definition file 9 (S603). Then, the switch terminates the starting process and starts the service.

When the client communication control unit 4 receives a request from the client, the request distributing unit 5 operates to select the most suitable server to processing the request by searching the server table 33 in which the equal identifier to the “name” parameter contained in the previous Bind request is registered in the area 37 and the numeric value registered in the request number 14 is the smallest from the processing status storing unit 6 (S701).

Then, the request distributing unit 5 operates to add “1” to the request number 14 of the selected server table 33 (S702). Then, the request distributing unit 5 further searches the connection table 11 in which the equal identifier to the server identifier 36 is registered in the area 35 and adds “1” to the value of the last message ID 13 (S703).

In succession, the request distributing unit 5 executes the same message sending process to that of the first embodiment and returns a response from the server to the client (S704 to S709). Then, the unit 5 subtracts “1” from the request number 14 (S710).

Next, the unit 5 deletes the client message ID area 15 of the connection table 11 generated in the step S704 (S711) and then completes the distributing process of the request.

The foregoing description has concerned with the second embodiment of the invention. The second embodiment makes it possible to balance the load through the server pool. For example, if plural server pools are defined as shown in FIG. 9, for balancing the load, three servers are allocated for an access from the client with its identify “cn=search, o=abc.com” and two servers are allocated for an access from the client with its identify “cn=update, o=abc.com”. The switch of this embodiment grasps the sum of the requests being processed, distributed from each pool, as a load of the server and selects the most suitable server based on the sum. As shown in the example of FIG. 9, hence, two servers may be used by different pools for balancing the load.

In the foregoing second embodiment, as means of selecting a server pool by a client, the parameter “name” of the Bind request is used. In place, however, the other existing standard parameter rather than the “name” may be used as a pool identifier. Or, the pool identifier may be specified by using the “Control” and the “Extendedrequest” defined in RFC2251. Further, the pool identifier 38 of FIG. 9 may be specified as “search” and “update”. If the request received from the client is a search request such as “search” and “compare”, the request is distributed into any server belonging to the “search” pool, while if the request received is an update request such as “Add”, “Delete”, “Modify”, and “Modify DN”, the request is distributed into any server belonging to the “update” pool.

In each of the foregoing embodiments, if the switch needs authentication for establishing a connection with each server, the authentication information such as a user ID and a password may be added to the server name of the server pool definition file 9. In the step S601, the switch may be connected with the server through the use of the authentication information.

In each of the foregoing embodiments, all servers to which the load is to be distributed are connected with the switch when it is started. However, not when the switch is started but when the Bind request from the client is received, the server may be connected with all servers.

In a case that authentication is needed for connecting the switch with the server, the connection with the server may be established by using the authentication information included in the Bind request from the client without adding the authentication information such as the user ID and the password to the server name 16 of the server pool definition file 9.

The LDAP may issue a new request on the single connection without waiting for the response to the priory request. Hence, if the same Bind request from another client is received, without having to establish a new connection with the server, the existing connection may be used for later request distribution.

In each of the foregoing embodiments, in receipt of the Bind request for establishing the LDAP connection from the client, without having to send the request to any one of the servers, the response of indicating that the connection is successfully established is returned to the client. However, if it is necessary to authenticate the client, the received Bind request may be sent to any one of the servers and the response from the server is returned to the client. In this case, if the redundant LDAP connection is established between the servers by the Bind request, immediately after connected, the connection may be disconnected by the Unbind request, for inhibiting the wasteful consumption of an memory area.

Further, the authentication information such as a user ID and a password included in the Bind request sent to the server may be temporarily stored in the storage area. Or, the authentication information may be added to the server name 16 of the server pool definition file 9. Later, if the Bind request is received, the authentication information included in the Bind request may be checked with the stored authentication information without sending the request to any one of the servers and then the response of indicating whether the connection is successful or not may be returned to the client. This operation allows the load processing of the server to be reduced more.

In each of the foregoing embodiments, it is described that the switch is operated in another information processing apparatus rather than the server and the client connected with the network. However, the switch may be arranged to be operated in the same information processing apparatus in which the server or the client is operated. This arrangement may offer the same effect.

In each of the foregoing embodiments, it is described that the switch selects the most suitable server based on the number of outstanding requests of each server. However, the switch may be arranged to select the most suitable server not by the number of outstanding requests but by the proper technique to measuring the load of the server such as CPU load. Moreover, the most suitable server may be selected by the technique such as a round robbin to be more easily implemented.

The foregoing embodiments have concerned with the application of the present invention to the directory system. In place, the present invention may be effectively applied to any kind of information processing system that may send plural requests on a single connection, such as a relational database management system or an object oriented database management system.

In each of the foregoing embodiments, the switch is arranged to distribute each of a series of requests on the same connection, received from the client, to the most suitable server on the receipt time. However, some processes such as the transaction processing request a series of requests to be sent to the same server. In correspondence with this operation, for example, in the foregoing second embodiment, the rule which indicates whether decomposition of a series of requests is permissible or not may be added to each server pool definition information in the server pool definition file 9. When a series of requests is received to the server pool where decomposition is allowed, the switch distributes each request to the optimum server (each may be a different server), like the second embodiment. On the other hand, when a series of requests is received to the server pool where decomposition is not allowed, the switch sends each request to a single server.

The foregoing embodiments are not concerned with the response to the request. In actual, the corresponding response is returned from the destination server to which the request is sent. Hence, the load is balanced on a unit of an operation consisting of the request and the response.

According to the invention, the load of each server is made more uniform and the stable response performance may be achieved in the overall system. This allows the cost to be reduced as keeping the convenience of the user.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A server load balancing system including a plurality of servers and one or more clients, comprising:
a server pool defining unit of storing information about said servers as a server pool;
a processing status storing unit of storing a processing status of each of said servers; and
a request distributing unit of selecting a server to which said request is to be sent by referring to said processing status storing unit when each request is received from said client and of sending said request to said selected server.

2. A server load balancing system as claimed in claim 1, wherein said request distributing unit sends the requests received through different connections with said client to said the server through same connection.

3. A server load balancing system as claimed in claim 1, wherein said processing status storing unit stores the number of outstanding requests of said each server, and said request distributing unit sends said request to said server with the least number of outstanding requests by referring to said processing status storing unit.

4. A server load balancing system as claimed in claim 1, wherein said server pool defining unit stores a plurality of server pools.

5. A server load balancing system as claimed in claim 4, wherein the information about said each server inside of said server pool defining unit belongs to at least one of said server pools.

6. A server load balancing system as claimed in claim 1, wherein said request distributing unit selects a target server to which said request is to be sent according to a request type.

7. A server load balancing device used in an information processing system composed of a plurality of servers and clients, comprising:
a server pool defining unit of storing information about said plural servers as a server pool;
a processing status storing unit of storing the processing status of said each server; and
a request distributing unit of selecting said server to which said request is to be sent by referring to said processing status storing unit when each request is received from said client and then sending said request to said selected server.
